(19) United States
(12) Patent Application Publication
(10) Pub. No.: US 2024/0326864 A1
(43) Pub. Date: Oct. 3, 2024

(54) TRAVELING SYSTEM OF AUTONOMOUS TRAVELING VEHICLE AND METHOD EXECUTED BY TRAVELING SYSTEM OF AUTONOMOUS TRAVELING VEHICLE

(71) Applicant: HONDA MOTOR CO., LTD., Tokyo (JP)

(72) Inventors: Peng Zhang, Wako-shi (JP); Shintaro Hidaka, Wako-shi (JP); Satoshi Hatori, Wako-shi (JP); Takuma Mori, Wako-shi (JP)

(21) Appl. No.: 18/129,160

(22) Filed: Mar. 31, 2023

(51) Int. Cl. B60W 60/00; B60W 30/09; B60W 30/095; G01S 17/931

(52) U.S. Cl. CPC B60W 60/0015; B60W 30/09; B60W 30/0956; G01S 17/931; B60W 2420/408; B60W 2556/40

(57) ABSTRACT

To provide a traveling system of an autonomous traveling vehicle capable of executing navigation even when there is an obstacle on a node in topological navigation and a method executed by the traveling system of an autonomous traveling vehicle.

The traveling system of an autonomous traveling vehicle that travels on a route constituted by a plurality of nodes and edges is provided, wherein the autonomous traveling vehicle determines passage of the nodes by passing over the nodes, and the traveling system includes: a processing unit that, in a case where there is an obstacle on the node, transitions the node outside an occupied range of the obstacle or expands the node so that the node is outside the occupied range of the obstacle; and a control unit that controls traveling of the autonomous traveling vehicle on the basis of the node transitioned or expanded by the processing unit.

### BACKGROUND OF THE INVENTION

### Field of the Invention

The present invention relates to a traveling system of an autonomous traveling vehicle and a method executed by the traveling system of an autonomous traveling vehicle.

### Description of Related Art

In topological navigation, navigation is performed by causing an autonomous traveling vehicle to sequentially pass through nodes and edges on the basis of a map in which a plurality of nodes (points) and edges (lines) are combined with each other.

As a technique of calculating a movement route constituted by a plurality of nodes and edges, a technique of increasing the probability of calculating a non-interference route not including nodes that interfere with obstacles is known (see, for example, Patent Document 1). This technique involves determining an interference of nodes included in route information on the basis of environmental information, generating additional nodes around nodes determined to have the interference based on the determination, and replacing the nodes determined to have interference with the additional nodes in accordance with the determination result of interference of the additional nodes based on the determination.

### PATENT DOCUMENT

[Patent Document 1] Japanese Unexamined Patent Application, First Publication No. 2012-190405

### SUMMARY OF THE INVENTION

When there is an obstacle larger than a node on the node will be described. In a case where the node is a passing node, an autonomous traveling vehicle cannot pass through the node due to the presence of an obstacle. In a case where the node is a destination node, the autonomous traveling vehicle cannot arrive at the node due to the presence of an obstacle. As a result, the autonomous traveling vehicle cannot complete navigation normally.

One object of the present invention is to provide a traveling system of an autonomous traveling vehicle capable of continuing navigation even when there is an obstacle on a node in topological navigation and a method executed by the traveling system of an autonomous traveling vehicle.

The following configurations are adopted in a processing device according to this invention.
(1) According to an aspect of this invention, there is provided a traveling system of an autonomous traveling vehicle that travels on a route constituted by a plurality of nodes and edges, wherein the autonomous traveling vehicle determines passage of the nodes by passing over the nodes, and the traveling system includes: a processing unit that, when there is an obstacle on the node, transitions the node outside an occupied range of the obstacle or expands the node so that the node is outside the occupied range of the obstacle; and a control unit that controls traveling of the autonomous traveling vehicle on the basis of the node transitioned or expanded by the processing unit.
(2) In the aspect of the above (1), when there is an obstacle on the node, the processing unit transitions or expands the node in a direction intersecting the edge located in front of or behind the node and outside the occupied range of the obstacle.
(3) In the aspect of the above (1) or (2), when there is an obstacle on the node, the processing unit expands the node outside the occupied range of the obstacle.
(4) In the aspect of the above (1), the autonomous traveling vehicle includes a sensor that detects an obstacle, performs an operation for avoiding the obstacle in a case where the obstacle is detected by the sensor, and transitions or expands a node outside the occupied range of the obstacle in a case where it is determined that passage of the node is not possible during the operation for avoiding the obstacle.
(5) In the aspect of the above (1), the control unit determines passage of the node by the autonomous traveling vehicle passing over the transitioned or expanded node.

The following configuration is adopted in a method which is executed by a traveling system of an autonomous traveling vehicle according to this invention.
(6) A method is provided and executed by a traveling system of an autonomous traveling vehicle that travels on a route constituted by a plurality of nodes and edges, wherein the autonomous traveling vehicle determines passage of the nodes by passing over the nodes, and the method executed by the traveling system includes: in a case where there is an obstacle on the node, transitioning the node outside an occupied range of the obstacle or expanding the node so that the node is outside the occupied range of the obstacle; and controlling traveling of the autonomous traveling vehicle on the basis of the transitioned or expanded node.

According to (1) to (6), it is possible to continue navigation even when there is an obstacle on a node in topological navigation.

### BRIEF DESCRIPTION OF THE DRAWINGS

FIG. 1 is a diagram illustrating an example of an operation of a traveling system of an autonomous traveling vehicle according to the present embodiment.

FIG. 2 is a diagram illustrating an example of an operation of the traveling system of the autonomous traveling vehicle according to the present embodiment.

FIG. 3A is a diagram illustrating an example of an operation of the traveling system of the autonomous traveling vehicle according to the present embodiment.

FIG. 3B is a diagram illustrating an example of an operation of the traveling system of the autonomous traveling vehicle according to the present embodiment.

FIG. 4 is a diagram illustrating an example of an operation of the traveling system of the autonomous traveling vehicle according to the present embodiment.

FIG. 5 is a diagram illustrating an example of an operation of the traveling system of the autonomous traveling vehicle according to the present embodiment.

FIG. 6 is a diagram illustrating an example of an operation of the traveling system of the autonomous traveling vehicle according to the present embodiment.

FIG. 7 is a diagram illustrating an example of the autonomous traveling vehicle according to the present embodiment.

FIG. 8 is a flowchart illustrating an example of an operation of the autonomous traveling vehicle according to the present embodiment.

FIG. 9 is a diagram illustrating an example of a traveling system of an autonomous traveling vehicle according to a modification example of the embodiment.

FIG. 10 is a flowchart illustrating an example of an operation of the autonomous traveling vehicle and the traveling system according to the modification example of the embodiment.

### DETAILED DESCRIPTION OF THE INVENTION

Next, a traveling system of an autonomous traveling vehicle and a method executed by the traveling system of an autonomous traveling vehicle according to the present embodiment will be described with reference to the accompanying drawings. An embodiment to be described below is merely an example, and embodiments to which the present disclosure is applied are not limited to the following embodiment. In all the drawings used to describe the embodiment, elements having the same functions are denoted by the same reference numerals and signs, and thus, description thereof will not be repeated.

In addition, the wording “on the basis of XX” used in this specification means “based on at least XX,” and also includes cases based on other elements in addition to XX. In addition, the wording “on the basis of XX” also includes a case based on an arithmetic operation or processing being performed on XX without being limited to a case in which XX is used directly. The term “XX” refers to any element (for example, any information).

### Embodiment

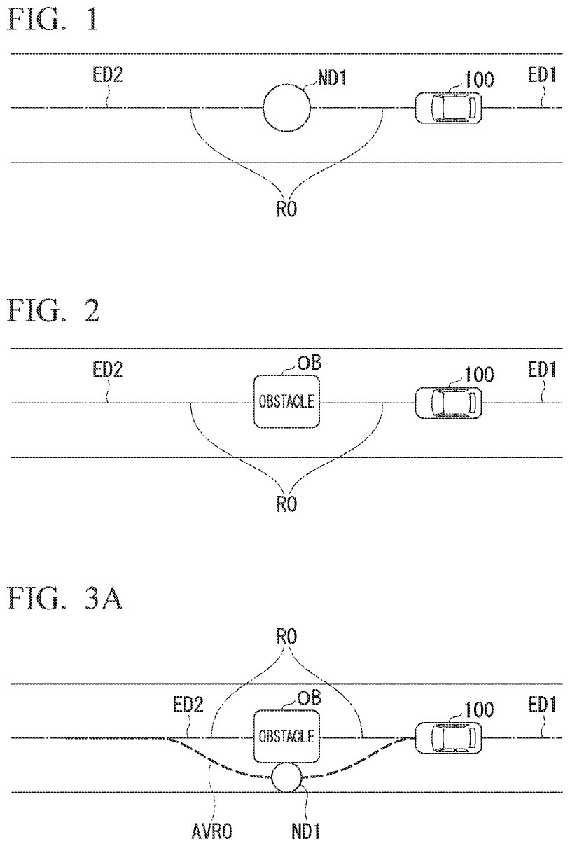

Hereinafter, an embodiment of the present invention will be described in detail with reference to the accompanying drawings. FIG. 1 is a diagram illustrating an example of an operation of a traveling system of an autonomous traveling vehicle according to the present embodiment.

The traveling system of an autonomous traveling vehicle controls traveling of an autonomous traveling vehicle 100. The traveling system performs navigation using a map (hereinafter referred to as a “topological map”) in which a plurality of nodes ND1 to NDm (m is an integer of m>0) and a plurality of edges ED1 to n (n is an integer of n>0) are combined with each other.

Hereinafter, any node among the nodes ND1 to NDm is referred to as a node ND, and any edge among the edges ED1 to EDn is referred to as an edge ED. The topological map is map data formed by connecting a large number of nodes ND through the edge ED. That is, the topological map is a representation of a real environment map with a large number of nodes ND connected to each other through the edge ED. For example, a road in the real environment may be represented by the edge ED, and any position on the road may be represented by the node ND. Here, the size of the node ND is determined on the basis of, for example, an error in the estimation position of the autonomous traveling vehicle 100. That is, at least some of the sizes of the plurality of nodes ND may differ.

The traveling system generates a route RO, for example, by determining the plurality of nodes ND and edges ED through which an image indicating the autonomous traveling vehicle 100 on the topological map is sequentially passed from a departure point and a destination. The traveling system performs navigation by causing the autonomous traveling vehicle 100 to travel in a real environment on the basis of the plurality of nodes ND and edges ED included in the generated route RO.

In addition to the image indicating the autonomous traveling vehicle 100, FIG. 1 shows a node ND1 among the plurality of nodes ND determined on the topological map and edges ED1 and ED2 among the plurality of edges ED determined on the topological map. The node ND1, the edge ED1, and the edge ED2 are included in the route RO.

Although there are no edges and nodes in the real environment, for convenience of description, it is assumed below that there are a route RRO in the real environment corresponding to the route RO determined on the topological map, an edge REDm in the real environment corresponding to the edge EDm determined on the topological map, and a node RNDn in the real environment corresponding to the node NDn determined on the topological map.

The autonomous traveling vehicle 100 travels on the route RRO in the real environment corresponding to the route RO determined on the topological map by the traveling system through navigation of the traveling system. The autonomous traveling vehicle 100 travels along the edge RED1 in the real environment corresponding to the edge ED1 determined on the topological map, arrives at the node RND1 in the real environment corresponding to the node ND1 determined on the topological map, and passes over the node RND1 in the real environment corresponding to the node ND1 determined on the topological map.

The traveling system determines passage of the node ND1 determined on the topological map by the autonomous traveling vehicle 100 passing over the node RND1 in the real environment. After the traveling system determines passage of the node ND1 determined on the topological map, the autonomous traveling vehicle 100 travels along the edge RED2 in the real environment corresponding to the edge ED2 determined on the topological map.

FIG. 2 is a diagram illustrating an example of an operation of the traveling system of the autonomous traveling vehicle according to the present embodiment. FIG. 2 differs from FIG. 1 in that there is an obstacle ROB which is larger than the node RND1 on the node RND1 in the real environment.

The autonomous traveling vehicle 100 includes, for example, a sensor that detects a distance. The traveling system detects the presence of the obstacle ROB on the node RND1 through information from the sensor. In a case where the size of the obstacle ROB is larger than the size of the node RND1, the traveling system displays an image indicating an obstacle OB corresponding to the obstacle ROB on the basis of the size and orientation of the obstacle ROB superimposed over the node ND1 on the topological map.

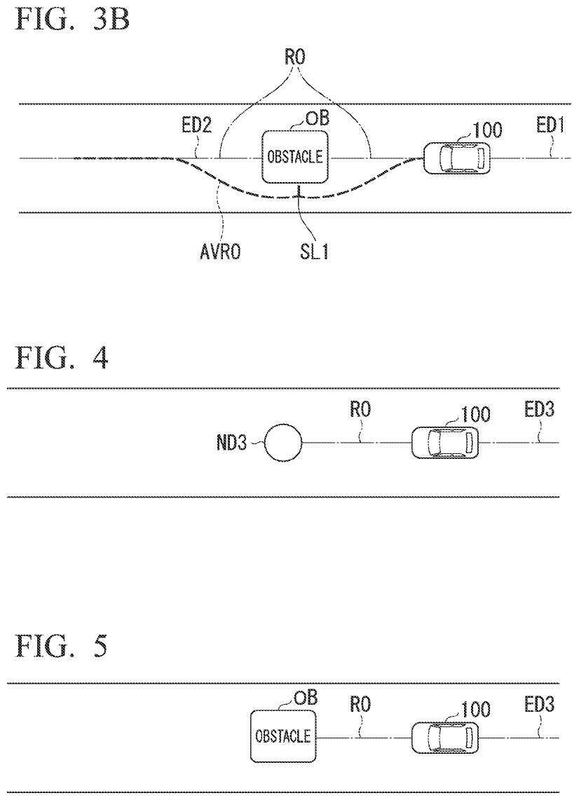

FIG. 3A is a diagram illustrating an example of an operation of the traveling system of the autonomous traveling vehicle according to the present embodiment. The traveling system determines a route to avoid an image of the autonomous traveling vehicle 100 passing over an image of the obstacle OB (hereinafter referred to as an “avoidance route AVRO”) by transitioning the node ND1 outside the occupied range of an image indicating the obstacle OB and determining a route to pass through the transitioned node ND1. The traveling system controls traveling of the autonomous traveling vehicle 100 so as to pass through an avoidance route RAVRO in the real environment corresponding to the avoidance route AVRO determined on the topological map.

The traveling system determines passage of the node ND1 transitioned by the traveling system on the topological map by the autonomous traveling vehicle 100 passing over the node RND1 in the real environment corresponding to the transitioned node ND1. After the traveling system determines passage of the transitioned node ND1, the autonomous traveling vehicle 100 returns from the avoidance route RAVRO to the route RRO in the real environment and travels along the edge RED2.

FIG. 3B is a diagram illustrating an example of an operation of the traveling system of the autonomous traveling vehicle according to the present embodiment. The traveling system determines a route to avoid an image of the autonomous traveling vehicle 100 passing over an image of the obstacle OB (hereinafter referred to as the “avoidance route AVRO”) by changing the node ND1 to a straight line SL1 orthogonal to the edges ED1 and ED2 with the center of the node ND1 as a starting point, expanding the straight line SL1 outside the occupied range of the image indicating the obstacle OB, and determining a route to pass through the end point of the expanded straight line SL1. The traveling system controls traveling of the autonomous traveling vehicle 100 so as to pass through the avoidance route RAVRO in the real environment corresponding to the avoidance route AVRO determined on the topological map.

The traveling system determines passage of the node ND1 corresponding to the straight line SL1 expanded by the traveling system on the topological map by the autonomous traveling vehicle 100 passing over an intersection point RIP in the real environment corresponding to an intersection point IP between the expanded straight line SL1 and the avoidance route AVRO. After the traveling system determines passage of the node ND1 corresponding to the expanded straight line SL1, the autonomous traveling vehicle 100 returns from the avoidance route RAVRO to the route RRO in the real environment and travels along the edge RED2. Hereinafter, as an example, a case where the traveling system transitions the node ND1 outside the occupied range of the image indicating the obstacle OB and determines a route to pass through the transitioned node ND1 will be described continuously.

FIG. 4 is a diagram illustrating an example of an operation of the traveling system of the autonomous traveling vehicle according to the present embodiment. FIG. 4 shows a node ND3 among the plurality of nodes ND determined on the topological map and an edge ED3 among the plurality of edges ED determined on the topological map. Here, the node ND3 is a node corresponding to the destination.

The autonomous traveling vehicle 100 travels along an edge RED3 corresponding to the edge ED3 determined on the topological map in the real environment through navigation of the traveling system and arrives at a node RND3. The traveling system determines arrival at the node ND3 determined on the topological map by the autonomous traveling vehicle 100 arriving at the node RND3 in the real environment. After the traveling system determines arrival at the node ND3, the autonomous traveling vehicle 100 stops.

FIG. 5 is a diagram illustrating an example of an operation of the traveling system of the autonomous traveling vehicle according to the present embodiment. FIG. differs from FIG. 4 in that the obstacle ROB is larger than the node RND3 is on the node RND3 in the real environment.

The autonomous traveling vehicle 100 includes, for example, a sensor that detects a distance. The traveling system detects the presence of the obstacle ROB on the node RND3 through information from the sensor. In a case where the obstacle ROB is larger than the node RND3, the traveling system creates an image indicating the obstacle OB corresponding to the obstacle ROB on the basis of the size and orientation of the obstacle ROB superimposed over the node ND3 on the topological map.

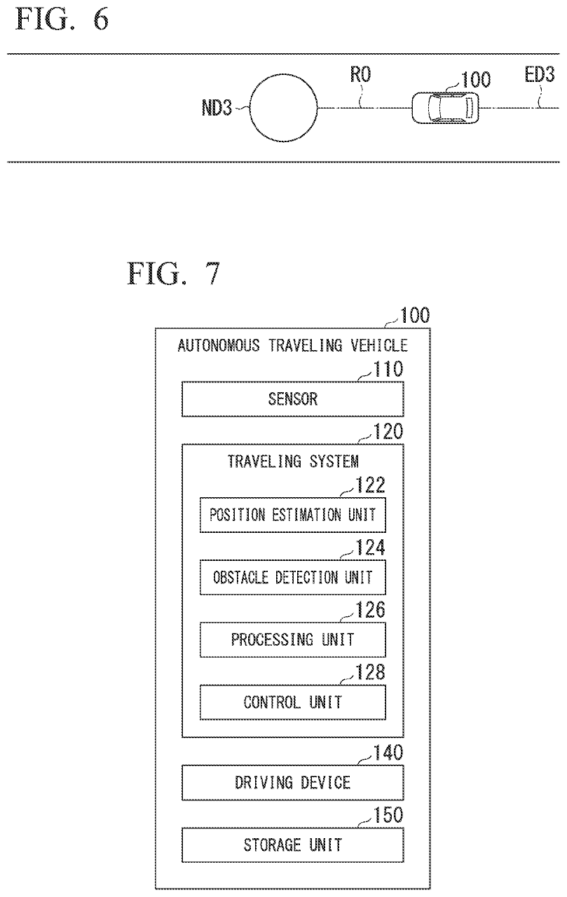

FIG. 6 is a diagram illustrating an example of an operation of the traveling system of the autonomous traveling vehicle according to the present embodiment.

The traveling system expands the node ND3 so as to be outside the occupied range of the created image indicating the obstacle OB. The traveling system controls traveling of the autonomous traveling vehicle 100 so as to arrive at an area of the expanded node RND3 in the real environment where the obstacle ROB does not interfere corresponding to an area of the expanded node ND3 where the obstacle OB does not interfere.

The traveling system determines arrival at the node ND3 determined on the topological map by the autonomous traveling vehicle 100 arriving at an area of the expanded node RND3 in the real environment where the obstacle ROB does not interfere.

Hereinafter, the autonomous traveling vehicle 100 according to the present embodiment will be described in detail.

FIG. 7 is a diagram illustrating an example of the autonomous traveling vehicle according to the present embodiment. The autonomous traveling vehicle 100 includes a sensor 110, a traveling system 120, a driving device 140, and a storage unit 150.

The sensor 110 measures, for example, a distance to any object in the traveling direction of the autonomous traveling vehicle 100. The sensor 110 is configured to include, for example, a light detection and ranging (LiDAR). The LiDAR measures a three-dimensional distance to an object which is a target of measurement and extracts point cloud data from the measured three-dimensional distance.

The storage unit 150 is realized by a hard disk drive (HDD), a flash memory, a random access memory (RAM), a read only memory (ROM), or the like, and stores information. For example, the storage unit 150 stores a topological map.

The driving device 140 is constituted by an actuator, an encoder, and its control device, which are not shown, and a movement mechanism having a plurality of combinations of wheels and steering shafts connected to the output shaft of the actuator. The movement mechanism is driven on the basis of a movement command from the traveling system 120.

The traveling system 120 is realized by a device such as a personal computer, a server, a smartphone, a tablet computer, or an industrial computer. The traveling system 120 controls traveling of the autonomous traveling vehicle 100. The traveling system 120 includes a position estimation unit 122, an obstacle detection unit 124, a processing unit 126, and a control unit 128.

The position estimation unit 122 estimates the position of the autonomous traveling vehicle 100. For example, the position estimation unit 122 is configured to include a global navigation satellite system (GNSS) and performs position measurement using signals emitted from navigation satellites.

The obstacle detection unit 124 acquires point cloud data from the sensor 110 and determines whether the obstacle ROB is in the traveling direction of the autonomous traveling vehicle 100 on the basis of the acquired point cloud data. In a case where it is determined that the obstacle ROB is in the traveling direction of the autonomous traveling vehicle 100, the obstacle detection unit 124 detects the three-dimensional position, size, and orientation (orientation (direction) with respect to a certain reference) of the obstacle ROB.

The processing unit 126 acquires the topological map stored in the storage unit 150. The processing unit 126 sets the route RO from the departure point to the destination on the acquired topological map on the basis of the departure point and destination designated by a user. In addition, the processing unit 126 displays an image of the autonomous traveling vehicle 100 on the topological map on the basis of the topological map and information on the position of the autonomous traveling vehicle 100 derived by the position estimation unit 122. For example, the processing unit 126 obtains a position on the topological map corresponding to the position of the autonomous traveling vehicle 100 in the real environment derived by the position estimation unit 122 at a predetermined period, and displays an image of the autonomous traveling vehicle 100 at the obtained position on the topological map. With this configuration, it is possible to ascertain the movement of the autonomous traveling vehicle 100 in the real environment on the topological map.

The processing unit 126 determines in the real environment whether the autonomous traveling vehicle 100 has passed through the passing node RND or has arrived at the node RND determined as a destination. The processing unit 126 performs a process of passing through the passing node ND and a process of arriving at the node ND determined as a destination on the topological map on the basis of the determination result. Specifically, the processing unit 126 draws a perpendicular line from the center of the transitioned node RND to the edge, and determines whether the autonomous traveling vehicle 100 has passed through the intersection point between the perpendicular line and the route created by the traveling system. The processing unit 126 performs a process of passing through the passing node ND in a case where the autonomous traveling vehicle 100 has passed through the intersection point between the perpendicular line and the route created by the traveling system and does not perform the process of passing through the passing node ND in a case where it has not passed through the intersection point. In addition, the processing unit 126 determines whether any portion of the autonomous traveling vehicle 100 has arrived at the expanded node RND. The processing unit 126 performs the process of arriving at the node ND determined as a destination in a case where any portion of the autonomous traveling vehicle 100 has arrived at the expanded node RND and does not perform the process of arriving at the node ND determined as a destination in a case where it has not arrived at the node.

In a case where the obstacle detection unit 124 determines that the obstacle ROB is in the traveling direction of the autonomous traveling vehicle 100, the processing unit 126 acquires information indicating the three-dimensional position, size, and direction of the obstacle ROB from the obstacle detection unit 124. The processing unit 126 displays the obstacle OB on the topological map on the basis of the acquired information indicating the three-dimensional position, size, and direction of the obstacle ROB. For example, the processing unit 126 obtains a position on the topological map corresponding to the acquired three-dimensional position of the obstacle ROB, and displays an image of the obstacle OB at the obtained position on the topological map on the basis of the information indicating the size and direction of the obstacle ROB. With this configuration, it is possible to ascertain the obstacle ROB in the real environment using the image of the obstacle OB displayed on the topological map.

In a case where the obstacle detection unit 124 determines that the obstacle ROB is in the traveling direction of the autonomous traveling vehicle 100, the processing unit 126 creates a first avoidance route FAVRO for avoiding collision with the obstacle OB on the basis of the plurality of nodes ND and edges ED and the obstacle OB displayed on the topological map. For example, the processing unit 126 creates the first avoidance route FAVRO for avoiding collision with the obstacle OB using a local planner. The local planner is an algorithm for avoiding the obstacle OB. Specifically, the processing unit 126 may create the first avoidance route FAVRO for avoiding the obstacle OB using time elastic band (TEB), may create the first avoidance route FAVRO for avoiding the obstacle OB using model projective control (MPC), or may create the first avoidance route FAVRO for avoiding the obstacle OB using dynamic window approach (DWA).

The processing unit 126 determines whether the autonomous traveling vehicle 100 can arrive at the node ND on the basis of the plurality of nodes ND and edges ED and the obstacle OB displayed on the topological map. In other words, the processing unit 126 determines whether the obstacle OB is larger than the node ND.

In a case where it is determined that the autonomous traveling vehicle 100 can arrive at the node ND, in other words, the obstacle OB is smaller than the node ND, the processing unit 126 updates the route by changing at least a portion of the set route to the first avoidance route FAVRO.

In a case where it is determined that the autonomous traveling vehicle 100 cannot arrive at the node ND, in other words, the obstacle OB is larger than the node ND, the processing unit 126 determines whether the node ND is a node determined to pass through or a node determined as a destination.

The overall three-dimensional shape of an obstacle (such as depth in the direction of traveling) may become apparent as the vehicle travels along the avoidance route. Therefore, the processing unit 126 may determine whether the autonomous traveling vehicle 100 can arrive at the node ND at the moment when the depth is known as a result of dynamic avoidance traveling in a case where the depth is not known originally.

In a case where it is determined that the node ND is a node determined to pass through, the processing unit 126 transitions the node ND outside the occupied range of the obstacle OB. For example, the processing unit 126 transitions the node ND in a direction intersecting the edge ED located in front of or behind the node ND and outside the occupied range of the obstacle OB. The processing unit 126 creates a second avoidance route SAVRO so as to pass through the transitioned node ND1. The processing unit 126 updates the route by changing at least a portion of the set avoidance route to the second avoidance route SAVRO.

In a case where it is determined that the node is a destination node, the processing unit 126 expands the node ND so as to be outside the occupied range of the obstacle OB. For example, the processing unit 126 expands the node ND in a direction intersecting the edge ED located in front of or behind the node ND and outside the occupied range of the obstacle OB. The processing unit 126 may expand the node ND on the basis of the width of the route (road width). As a result of expanding the node ND, the shape of the node ND may be circular or may be elliptical. Alternatively, as shown in FIG. 3B, the node ND may be expanded so as to expand linearly in a direction orthogonal to the edge ED located in front of or behind the node ND. The processing unit 126 creates an arrival route ARO so as to arrive at an area of the expanded node ND where an interfering object OB does not interfere. The processing unit 126 updates the route by changing at least a portion of the set avoidance route to the arrival route ARO.

The control unit 128 controls traveling of the autonomous traveling vehicle 100 so that the vehicle passes through a route set by the processing unit 126. The control unit 128 controls traveling of the autonomous traveling vehicle 100 by outputting the axle speed of the wheels or the like to the driving device 140 as a movement command.

The position estimation unit 122, the obstacle detection unit 124, the processing unit 126, and the control unit 128 are realized, for example, by a hardware processor such as a central processing unit (CPU) executing a computer program (software) stored in the storage unit 150.

In addition, some or all of these functional units may be realized by hardware (a circuit unit; including circuitry) such as a large scale integration (LSI), an application specific integrated circuit (ASIC), a field-programmable gate array (FPGA), or a graphics processing unit (GPU), or may be realized by software and hardware in cooperation.

The computer program may be stored in a storage device such as an HDD or a flash memory in advance, may be stored in a detachable storage medium such as a digital versatile disc (DVD) or a CD-ROM, or may be installed by the storage medium being mounted in a drive device.

### (Operation of the Autonomous Traveling Vehicle 100)

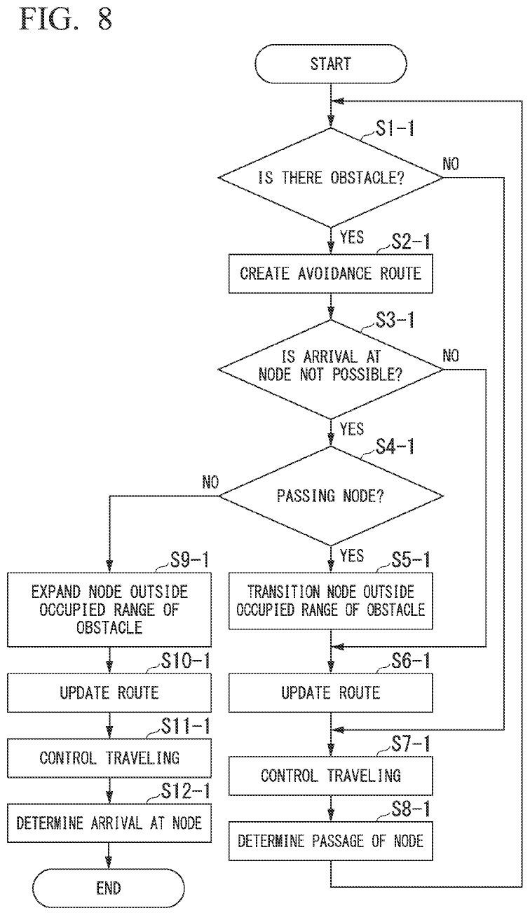

FIG. 8 is a flowchart illustrating an example of an operation of the autonomous traveling vehicle according to the present embodiment. Reference will be made to FIG. 8 to describe the operation of the autonomous traveling vehicle 100 after the route RO from the departure point to the destination is set on the topological map.

### (Step S1-1)

In the traveling system 120, the obstacle detection unit 124 acquires point cloud data from the sensor 110, and determines whether the obstacle ROB is in the traveling direction of the autonomous traveling vehicle 100 on the basis of the acquired point cloud data.

### (Step S2-1)

In the traveling system 120, in a case where the obstacle detection unit 124 determines that the obstacle ROB is on the node ND (step S1-1: YES), the processing unit 126 creates the first avoidance route FAVRO to avoid collision with the obstacle ROB.

### (Step S3-1)

In the traveling system 120, the control unit 128 determines whether the autonomous traveling vehicle 100 can arrive at the node ND on the basis of the plurality of nodes ND and edges ED and the obstacle OB displayed on the topological map.

### (Step S4-1)

In the traveling system 120, in a case where the processing unit 126 determines that arrival at the node ND is not possible (step S3-1: YES), the processing unit 126 determines whether the node ND is a passing node.

### (Step S5-1)

In the traveling system 120, in a case where it is determined that the node ND is a passing node (step S4-1: YES), the processing unit 126 transitions the node ND outside the occupied range of the obstacle OB.

### (Step S6-1)

In the traveling system 120, the processing unit 126 creates the second avoidance route SAVRO so as to pass through the transitioned node ND. The processing unit 126 updates the route by changing at least a portion of the created route to the second avoidance route SAVRO. Alternatively, in a case where it is determined in step S3-1 that arrival at the node ND is possible (step S3-1: NO), the processing unit 126 updates the route by changing at least a portion of the created route to the first avoidance route FAVRO.

### (Step S7-1)

In a case where the obstacle detection unit 124 determines in step S1-1 that no obstacle OB is on the node ND (step S1-1: NO) or after the route is updated in step S6-1, in the traveling system 120, the control unit 128 controls traveling of the autonomous traveling vehicle 100 so as to pass through the route created by the processing unit 126. The control unit 128 controls traveling of the autonomous traveling vehicle 100 by outputting the axle speed of the wheels or the like to the driving device 140 as a movement command.

### (Step S8-1)

In the traveling system 120, the processing unit 126 determines whether the autonomous traveling vehicle 100 has passed through the passing node RND in the real environment. The processing unit 126 performs a process of passing through the passing node ND on the topological map on the basis of the determination result. Thereafter, the process returns to step S1.

### (Step S9-1)

In the traveling system 120, in a case where it is determined that the node is not a passing node (step S4-1: NO), the processing unit 126 expands the node ND outside the occupied range of the obstacle OB.

### (Step S10-1)

In the traveling system 120, the processing unit 126 creates the arrival route ARO so as to arrive at an area of the expanded node ND where the interfering object OB does not interfere. The processing unit 126 updates the route by changing at least a portion of the set route to the arrival route ARO.

### (Step S11-1)

In the traveling system 120, the control unit 128 controls traveling of the autonomous traveling vehicle 100 so as to pass through the route created by the processing unit 126. The control unit 128 controls traveling of the autonomous traveling vehicle 100 by outputting the axle speed of the wheels or the like to the driving device 140 as a movement command.

### (Step S12-1)

In the traveling system 120, the processing unit 126 determines whether the autonomous traveling vehicle 100 has arrived at the node RND determined as a destination in the real environment. The processing unit 126 performs a process of arriving at the node ND determined as a destination on the topological map on the basis of the determination result. Thereafter, the process ends.

In step S4-1 of FIG. 8, it is determined whether the node ND is a passing node. However, instead, it may be determined whether avoidance traveling of deviating from the edge ED (the obstacle OB) is permitted on the edge ED where the autonomous traveling vehicle 100 is located.

In the above-described embodiment, in the traveling system 120, as an example, a case where the position estimation unit 122 is configured to include a global navigation satellite system and performs position measurement using signals emitted from navigation satellites has been described, but there is no limitation to this example. For example, the position estimation unit 122 may estimate a position using odometry. In odometry, the current position and posture are estimated by integrating the rotation angle of the wheel per unit time. In addition, for example, the position estimation unit 122 may be configured to include a map data group, acquire point cloud data from the sensor 110, and apply (match) the acquired point cloud data to the point cloud data of the map data group to estimate a position. In addition, the position estimation unit 122 may estimate a position by combining at least two of a method of performing position measurement using signals emitted from navigation satellites, a method of estimating a position using odometry, and a method of estimating a position by applying the point cloud data to the point cloud data of the map data group.

In the above-described embodiment, in the traveling system 120, a case where the processing unit 126 expands the node ND so as to be outside the occupied range of the obstacle OB when it is determined that the node is a destination node has been described, but there is no limitation to this example. For example, even in a case where it is determined that the node is a destination node, the processing unit 126 may transition the node ND outside the occupied range of the obstacle OB similarly to the node ND determined to pass through. For example, the processing unit 126 may transition the node ND forward or backward along the route RO, or may transition the node ND in a direction perpendicular to the edge ED before or after the node ND.

In the above-described embodiment, in the traveling system 120, the processing unit 126 may cause the autonomous traveling vehicle 100 to wait in a case where it is determined that the autonomous traveling vehicle 100 cannot be caused to pass through the node ND even when the node is transitioned outside the occupied range of the obstacle OB. For example, the processing unit 126 moves the autonomous traveling vehicle 100 to a position at a distance where the obstacle ROB can be confirmed by the control unit 128 and collision can be avoided due to the movement of the obstacle ROB. With this configuration, the autonomous traveling vehicle 100 can be caused to pass quickly in a case where the obstacle ROB is moved.

In addition, the processing unit 126 may cause the autonomous traveling vehicle 100 to wait in a case where it is determined that the autonomous traveling vehicle 100 cannot be caused to arrive at the node ND even when the node is expanded so as to be outside the occupied range of the obstacle OB. For example, the processing unit 126 moves the autonomous traveling vehicle 100 to a position at a distance where the obstacle ROB can be confirmed by the control unit 128 and collision can be avoided due to the movement of the obstacle ROB. With this configuration, the autonomous traveling vehicle 100 can be caused to arrive quickly in a case where the obstacle ROB is moved.

According to the traveling system 120 of the autonomous traveling vehicle 100 of the present embodiment, the autonomous traveling vehicle 100 travels on a route constituted by the plurality of nodes ND and edges ED. The autonomous traveling vehicle 100 determines passage of the node ND by passing over the node ND. The traveling system 120 includes the processing unit 126 that, in a case where the obstacle OB is on the node ND, transitions the node ND outside the occupied range of the obstacle OB or expands the node ND so that the node is outside the occupied range of the obstacle OB, and the control unit 128 that controls traveling of the autonomous traveling vehicle 100 on the basis of the node ND transitioned or expanded by the processing unit 126.

With this configuration, for example, in a case where the obstacle OB is on the node ND to pass through, the traveling system 120 can transition the node ND outside the occupied range of the obstacle OB, and thus, it is possible to continue navigation by causing the autonomous traveling vehicle 100 to pass through the transitioned node ND. In addition, for example, in a case where the obstacle OB is on the node ND that is a destination, the traveling system 120 can expand the node ND so as to be outside the occupied range of the obstacle OB, and thus, it is possible to continue navigation by causing the autonomous traveling vehicle 100 to arrive at the expanded node ND.

In the traveling system 120 of the autonomous traveling vehicle 100, in a case where the obstacle OB is on the node ND, the processing unit 126 transitions or expands the node ND in a direction intersecting the edge ED located in front of or behind the node ND and outside the occupied range of the obstacle OB.

With this configuration, the traveling system 120 can derive a route to bypass the obstacle OB and a route to avoid collision with the obstacle OB. Therefore, the traveling system 120 can continue navigation by causing the autonomous traveling vehicle 100 to pass through the transitioned node ND and arrive at the expanded node ND.

In the traveling system 120 of the autonomous traveling vehicle 100, in a case where the obstacle OB is on the node ND, the processing unit 126 expands the node outside the occupied range of the obstacle OB.

With this configuration, the traveling system 120 can derive a route to bypass the obstacle OB and a route to avoid collision with the obstacle OB. Therefore, the traveling system 120 can continue navigation by arriving at the expanded node ND.

In the traveling system 120 of the autonomous traveling vehicle 100, the autonomous traveling vehicle 100 includes the sensor 110 that detects the obstacle OB, performs an operation for avoiding the obstacle OB in a case where the obstacle OB is detected by the sensor 110, and transitions or expands the node ND outside the occupied range of the obstacle OB in a case where it is determined that passage of the node ND is not possible during the operation for avoiding the obstacle OB.

With this configuration, the traveling system 120 can transition or expand the node ND outside the occupied range of the obstacle OB in a case where it is determined that passage of the node ND is not possible during the operation for avoiding the obstacle OB, and thus, it is possible to reduce a processing load more than in a case where the node ND is transitioned or expanded outside the occupied range of the obstacle OB when the obstacle OB is detected by the sensor 110.

In the traveling system 120 of the autonomous traveling vehicle 100, the processing unit 126 determines passage of the node ND by the autonomous traveling vehicle 100 passing over the transitioned or expanded node ND.

With this configuration, the traveling system 120 can complete the process of passing through the node ND and can therefore proceed to the next process.

### Modification Example of Embodiment

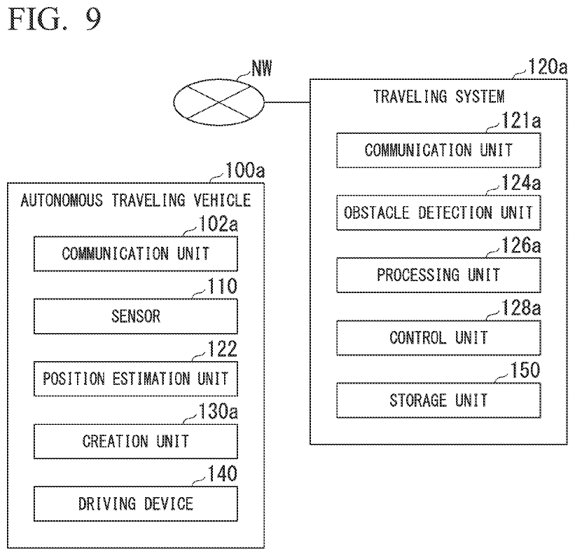

FIG. 9 is a diagram illustrating an example of a traveling system of an autonomous traveling vehicle according to a modification example of the embodiment. The traveling system of the autonomous traveling vehicle according to the modification example of the embodiment has an autonomous traveling vehicle 100a and a traveling system 120a configured as separate elements. The autonomous traveling vehicle 100a and the traveling system 120a communicate with each other through a network NW. The network NW includes, for example, the Internet, a wide area network (WAN), a local area network (LAN), a provider device, a wireless base station, or the like.

The traveling system 120a generates a route RO, for example, by determining a plurality of nodes ND and edges ED through which the autonomous traveling vehicle 100a is sequentially passed from a departure point and a destination. The traveling system 120a performs navigation by causing the autonomous traveling vehicle 100a to travel in a real environment on the basis of the plurality of nodes ND and edges ED included in the generated route RO.

As shown in FIG. 1, a case where the node ND1 is shown among the plurality of nodes ND determined on the topological map and the edge ED1 and the edge ED2 are shown among the plurality of edges ED determined on the topological map will be described. The node ND1, the edge ED1, and the edge ED2 are included in the route RO.

The autonomous traveling vehicle 100a travels on the route RRO in the real environment corresponding to the route RO determined on the topological map through navigation of the traveling system 120a. The autonomous traveling vehicle 100a travels along the edge RED1 in the real environment corresponding to the edge ED1 determined on the topological map, arrives at the node RND1 in the real environment corresponding to the node ND1 determined on the topological map and passes over the node RND1 in the real environment corresponding to the node ND1 determined on the topological map.

The traveling system 120a determines passage of the node ND1 determined on the topological map by the autonomous traveling vehicle 100a passing over the node RND1 in the real environment. After the traveling system 120a determines passage of the node ND1 determined on the topological map, the autonomous traveling vehicle 100a travels along the edge RED2 in the real environment corresponding to the edge ED2 determined on the topological map by the traveling system 120a.

As shown in FIG. 2, a case where an obstacle ROB which is larger than the node RND1 is on the node RND1 in the real environment will be described.

The autonomous traveling vehicle 100a includes, for example, a sensor that detects a distance. The traveling system 120a detects the presence of the obstacle ROB on the node RND1 through information from the sensor. In a case where the obstacle ROB is larger than the node RND1, the traveling system 120a displays an image indicating an obstacle OB corresponding to the obstacle ROB on the basis of the size of the obstacle ROB superimposed over the node ND1 on the topological map.

As shown in FIG. 3, the traveling system 120a determines the avoidance route AVRO to avoid passing over an image of the obstacle OB by transitioning the node ND1 outside the occupied range of an image indicating the obstacle OB and determining a route to pass through the transitioned node ND1. The traveling system 120a controls traveling of the autonomous traveling vehicle 100a so as to pass through the avoidance route RAVRO in the real environment corresponding to the avoidance route AVRO determined on the topological map.

The traveling system 120a determines passage of the transitioned node ND1 by the autonomous traveling vehicle 100a passing over the node RND1 in the real environment corresponding to the transitioned node ND1. After the traveling system 120a determines passage of the transitioned node ND1, the autonomous traveling vehicle 100a returns from the avoidance route RAVRO to the route RRO in the real environment and travels along the edge RED2.

As shown in FIG. 4, a case where the node ND3 is shown among the plurality of nodes ND determined on the topological map and the edge ED3 is shown among the plurality of edges ED determined on the topological map will be described. Here, the node ND3 is a node corresponding to the destination.

The autonomous traveling vehicle 100a travels along the edge RED3 corresponding to the edge ED3 determined on the topological map in the real environment through navigation of the traveling system 120a and arrives at the node RND3. The traveling system 120a determines arrival at the node ND3 determined on the topological map by the autonomous traveling vehicle 100a arriving at the node RND3 in the real environment. After the traveling system 120a determines arrival at the node ND3, the autonomous traveling vehicle 100a stops.

As shown in FIG. 5, a case where the obstacle ROB which is larger than the node RND3 is on the node RND3 in the real environment will be described.

The autonomous traveling vehicle 100a includes, for example, a sensor that detects a distance. The traveling system 120a detects the presence of the obstacle ROB on the node RND3 through information from the sensor. In a case where the obstacle ROB is larger than the node RND3, the traveling system 120a creates an image indicating the obstacle OB corresponding to the obstacle ROB on the basis of the size of the obstacle ROB superimposed over the node ND3 on the topological map.

As shown in FIG. 6, the traveling system 120a expands the node ND3 so as to be outside the occupied range of the created image indicating the obstacle OB. The traveling system 120a controls traveling of the autonomous traveling vehicle 100 so as to arrive at an area of the expanded node RND3 in the real environment where the obstacle ROB does not interfere corresponding to an area of the expanded node ND3 where the obstacle OB does not interfere.

The traveling system 120a determines arrival at the node ND3 determined on the topological map by the autonomous traveling vehicle 100 arriving at an area of the expanded node RND3 in the real environment where the obstacle ROB does not interfere.

Hereinafter, the autonomous traveling vehicle 100a and the traveling system 120a according to the modification example of the embodiment will be described in detail. The autonomous traveling vehicle 100a includes a communication unit 102a, the sensor 110, the position estimation unit 122, a creation unit 130a, the driving device 140, and the storage unit 150.

The communication unit 102a is realized by a communication module. The communication unit 102a communicates with an external communication device through a network NW. The communication unit 102a communicates using a wireless communication scheme such as, for example, a wireless LAN, Bluetooth (registered trademark), or LTE (registered trademark). The communication unit 102a holds communication information required for communicating with the traveling system 120a through the network NW.

The creation unit 130a acquires point cloud data from the sensor 110 and creates point cloud data notification information including the acquired point cloud data. The creation unit 130a transmits the created point cloud data notification information from the communication unit 102a to the traveling system 120a. The creation unit 130a acquires information on the position of the autonomous traveling vehicle 100a from the position estimation unit 122, and creates position notification information including the acquired information on the position of the autonomous traveling vehicle 100a. The creation unit 130a transmits the created position notification information from the communication unit 102a to the traveling system 120a.

The communication unit 102a receives a movement command transmitted by the traveling system 120a. The driving device 140 acquires the movement command from the communication unit 102a, and a movement mechanism is driven on the basis of the acquired movement command.

The position estimation unit 122 and the creation unit 130a are realized, for example, by a hardware processor such as a CPU executing a computer program (software) stored in in a storage unit (not shown).

In addition, some or all of these functional units may be realized by hardware (a circuit unit: including circuitry) such as an LSI, an ASIC, an FPGA, or a GPU, or may be realized by software and hardware in cooperation.

The computer program may be stored in a storage device such as an HDD or a flash memory in advance, may be stored in a detachable storage medium such as a DVD or a CD-ROM, or may be installed by the storage medium being mounted in a drive device.

The traveling system 120a includes a communication unit 121a, the obstacle detection unit 124a, the processing unit 126a, the control unit 128a, and the storage unit 150.

The communication unit 121a is realized by a communication module. The communication unit 121a communicates with an external communication device through the network NW. The communication unit 121a communicates using a wireless communication scheme such as, for example, a wireless LAN, Bluetooth (registered trademark), or LTE (registered trademark). The communication unit 121a may communicate using a communication scheme such as, for example, a wired LAN. The communication unit 121a holds communication information required for communicating with the autonomous traveling vehicle 100a through the network NW. The communication unit 121a receives the point cloud data notification information and position information notification transmitted by the autonomous traveling vehicle 100a.

The obstacle detection unit 124a can apply the obstacle detection unit 124. However, the obstacle detection unit 124a acquires the point cloud data notification information from the communication unit 121a and determines whether the obstacle ROB is in the traveling direction of the autonomous traveling vehicle 100a on the basis of the point cloud data included in the acquired point cloud notification information.

The processing unit 126a can apply the processing unit 126. However, the processing unit 126a acquires a position information notification from the communication unit 121a and acquires information on the position of the autonomous traveling vehicle 100a included in the acquired position information notification. The processing unit 126 displays an image of the autonomous traveling vehicle 100a on the topological map on the basis of the topological map and the acquired information on the position of the autonomous traveling vehicle 100.

The control unit 128a can apply the control unit 128. However, the control unit 128a transmits the movement command from the communication unit 121a to the autonomous traveling vehicle 100a.

The obstacle detection unit 124a, the processing unit 126a, the control unit 128a are realized, for example, by a hardware processor such as a CPU executing a computer program (software) stored in in a storage unit (not shown).

In addition, some or all of these functional units may be realized by hardware (a circuit unit; including circuitry) such as an LSI, an ASIC, an FPGA, or a GPU, or may be realized by software and hardware in cooperation.

The computer program may be stored in a storage device such as an HDD or a flash memory in advance, may be stored in a detachable storage medium such as a DVD or a CD-ROM, or may be installed by the storage medium being mounted in a drive device.

### (Operations of Autonomous Traveling Vehicle 100a and Traveling System 120a)

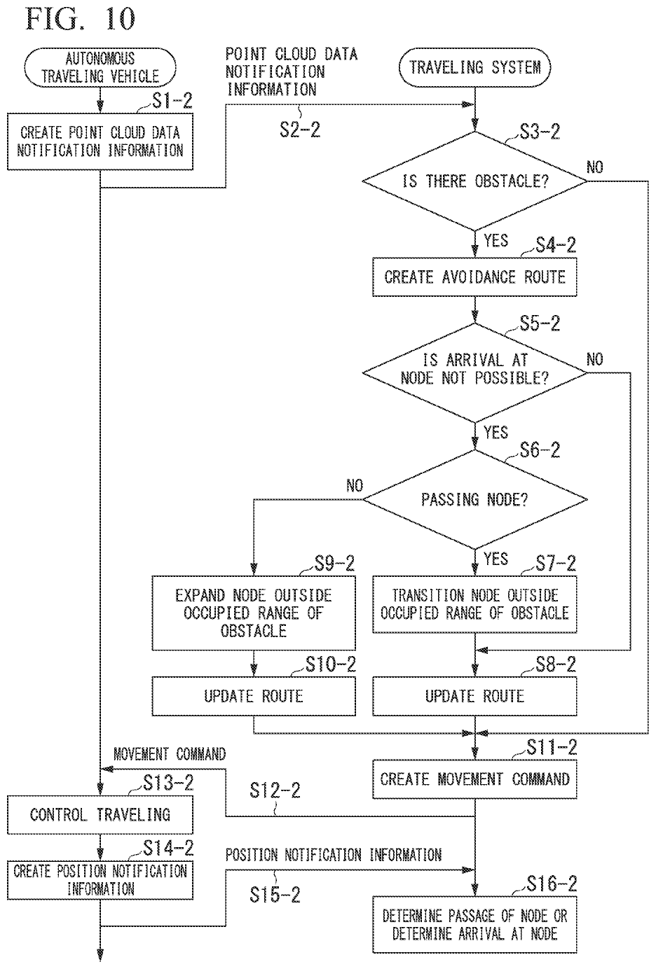

FIG. 10 is a flowchart illustrating an example of operations of the autonomous traveling vehicle and the traveling system according to the modification example of the embodiment. Reference will be made to FIG. 10 to describe operations of the autonomous traveling vehicle 100a and the traveling system 120a after the route RO from the departure point to the destination is set on the topological map.

### (Step S1-2)

In the autonomous traveling vehicle 100a, the creation unit 130a acquires point cloud data from the sensor 110 and creates point cloud data notification information including the acquired point cloud data.

### (Step S2-2)

In the autonomous traveling vehicle 100a, the creation unit 130a transmits the created point cloud data notification information from the communication unit 102a to the traveling system 120a.

### (Step S3-2)

In the traveling system 120a, the communication unit 121a receives the point cloud data notification information transmitted by the autonomous traveling vehicle 100a. The obstacle detection unit 124a acquires the point cloud data notification information from the communication unit 121a, and determines whether the obstacle ROB is in the traveling direction of the autonomous traveling vehicle 100a on the basis of the point cloud data included in the acquired point cloud notification information.

Steps S4-2 to S10-2 can be applied to steps S2-1 to S6-1 and S9-1 to S10-1 in FIG. 8, and thus, description thereof will be omitted here.

### (Step S11-2)

In the traveling system 120a, the control unit 128a creates a movement command on the basis of the set route, the route updated in step S8-2, or the route updated in S10-2.

### (Step S12-2)

In the traveling system 120a, the control unit 128a transmits the movement command from the communication unit 121a to the autonomous traveling vehicle 100a.

### (Step S13-2)

In the autonomous traveling vehicle 100a, the communication unit 102a receives the movement command transmitted by the traveling system 120a. The driving device 140 acquires the movement command from the communication unit 102a, and a movement mechanism is driven on the basis of the acquired movement command.

### (Step S14-2)

In the autonomous traveling vehicle 100a, the creation unit 130a acquires information on the position of the autonomous traveling vehicle 100a from the position estimation unit 122, and creates position notification information including the acquired information on the position of the autonomous traveling vehicle 100a.

### (Step S15-2)

In the autonomous traveling vehicle 100a, the creation unit 130a transmits the created position notification information from the communication unit 102a to the traveling system 120a.

### (Step S16-2)

In the traveling system 120a, the processing unit 126a determines in the real environment whether the autonomous traveling vehicle 100a has passed through the passing node RND or has arrived at the node RND determined as a destination. The processing unit 126a performs a process of passing through the passing node ND or a process of arriving at the node ND determined as a destination on the topological map on the basis of the determination result. The process returns to step S1-2 in a case where the passage process is performed, and the process ends in a case where the arrival process is performed.

According to the traveling system 120a of the autonomous traveling vehicle 100a of the modification example of the embodiment, the autonomous traveling vehicle 100a travels on a route constituted by the plurality of nodes ND and edges ED. The autonomous traveling vehicle 100a determines passage of the node ND by passing over the node ND. The traveling system 120a includes the processing unit 126a that, in a case where the obstacle OB is on the node ND, transitions the node ND outside the occupied range of the obstacle OB or expands the node ND so that the node is outside the occupied range of the obstacle OB, and the control unit 128a that controls traveling of the autonomous traveling vehicle 100a on the basis of the node ND transitioned or expanded by the processing unit 126a.

With this configuration, for example, in a case where the obstacle OB is on the node ND to pass through, the traveling system 120a can transition the node ND outside the occupied range of the obstacle OB, and thus, it is possible to continue navigation by causing the autonomous traveling vehicle 100a to pass through the transitioned node ND. In addition, for example, in a case where the obstacle OB is on the node ND that is a destination, the traveling system 120a can expand the node ND so as to be outside the occupied range of the obstacle OB, and thus, it is possible to continue navigation by causing the autonomous traveling vehicle 100a to arrive at the expanded node ND.

In the traveling system 120a of the autonomous traveling vehicle 100a, in a case where the obstacle OB is on the node ND, the processing unit 126a transitions or expands the node ND in a direction intersecting the edge ED located in front of or behind the node ND and outside the occupied range of the obstacle OB.

With this configuration, the traveling system 120a can derive a route to bypass the obstacle OB and a route to avoid collision with the obstacle OB. Therefore, the traveling system 120a can continue navigation by causing the autonomous traveling vehicle 100a to pass through the transitioned node ND and arrive at the expanded node ND.

In the traveling system 120a of the autonomous traveling vehicle 100a, in a case where the obstacle OB is on the node ND, the processing unit 126a expands the node outside the occupied range of the obstacle OB.

With this configuration, the traveling system 120a can derive a route to bypass the obstacle OB and a route to avoid collision with the obstacle OB. Therefore, the traveling system 120a can continue navigation by arriving at the expanded node ND.

In the traveling system 120a of the autonomous traveling vehicle 100a, the autonomous traveling vehicle 100a includes the sensor 110 that detects the obstacle OB, performs an operation for avoiding the obstacle OB in a case where the obstacle OB is detected by the sensor 110, and transitions or expands the node ND outside the occupied range of the obstacle OB in a case where it is determined that passage of the node ND is not possible during the operation for avoiding the obstacle OB.

With this configuration, the traveling system 120a can transition or expand the node ND outside the occupied range of the obstacle OB in a case where it is determined that passage of the node ND is not possible during the operation for avoiding the obstacle OB, and thus, it is possible to reduce a processing load more than in a case where the node ND is transitioned or expanded outside the occupied range of the obstacle OB when the obstacle OB is detected by the sensor 110.

In the traveling system 120a of the autonomous traveling vehicle 100a, the processing unit 126a determines passage of the node ND by the autonomous traveling vehicle 100a passing over the transitioned or expanded node ND.

With this configuration, the traveling system 120a can complete the process of passing through the node ND and can therefore proceed to the next process.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

100, 100a Autonomous traveling vehicle
102a, 121a Communication unit
110 Sensor
120, 120a Traveling system
122 Position estimation unit
124, 124a Obstacle detection unit
126, 126a Processing unit
128, 128a Control unit
130a Creation unit
140 Driving device
150 Storage unit

What is claimed is:

1. A traveling system of an autonomous traveling vehicle that travels on a route constituted by a plurality of nodes and edges,
wherein the autonomous traveling vehicle determines passage of the nodes by passing over the nodes, and
the traveling system comprises:
a processing unit that, in a case where there is an obstacle on the node, transitions the node outside an occupied range of the obstacle or expands the node so that the node is outside the occupied range of the obstacle; and
a control unit that controls traveling of the autonomous traveling vehicle on the basis of the node transitioned or expanded by the processing unit.

2. The traveling system of the autonomous traveling vehicle according to claim 1, wherein, in a case where there is an obstacle on the node, the processing unit transitions or expands the node in a direction intersecting the edge located in front of or behind the node and outside the occupied range of the obstacle.

3. The traveling system of the autonomous traveling vehicle according to claim 1 or 2, wherein, in a case where there is an obstacle on the node, the processing unit expands the node outside the occupied range of the obstacle.

4. The traveling system of the autonomous traveling vehicle according to claim 1, wherein the autonomous traveling vehicle includes a sensor that detects an obstacle, performs an operation for avoiding the obstacle in a case where the obstacle is detected by the sensor, and transitions or expands a node outside the occupied range of the obstacle in a case where it is determined that passage of the node is not possible during the operation for avoiding the obstacle.

5. The traveling system of the autonomous traveling vehicle according to claim 1, wherein the processing unit determines passage of the node by the autonomous traveling vehicle passing over the transitioned or expanded node.

6. A method executed by a traveling system of an autonomous traveling vehicle that travels on a route constituted by a plurality of nodes and edges,
wherein the autonomous traveling vehicle determines passage of the nodes by passing over the nodes, and
the method executed by the traveling system comprises:
in a case where there is an obstacle on the node, transitioning the node outside an occupied range of the obstacle or expanding the node so that the node is outside the occupied range of the obstacle; and
controlling traveling of the autonomous traveling vehicle on the basis of the transitioned or expanded node.
